(19) United States
(12) Patent Application Publication
(10) Pub. No.: US 2026/0279340 A1
(43) Pub. Date: Sep. 17, 2026

(54) Context-Aware Verbal and Non-Verbal Cue Detection

(71) Applicant: Sierra Technologies, Inc., San Francisco, CA (US)

(72) Inventors: Julien Zachary Reneau-Wedeen, San Francisco, CA (US); Julie Christina Tung, Los Altos, CA (US); Arya Asemanfar, San Francisco, CA (US)

(21) Appl. No.: 19/466,182

(22) Filed: Jan. 30, 2026

Related U.S. Application Data
(60) Provisional application No. 63/770,897, filed on Mar. 12, 2025.

(51) Int. Cl. G10L 15/06; G06N 20/00; G10L 15/02

(52) U.S. Cl. CPC G10L 15/063; G06N 20/00; G10L 15/02

(57) ABSTRACT

An agent of a system receives a voice input from a user during a real-time conversation between the agent and user. The system generates an input to a machine learning (ML) model. The input includes a user utterance in the voice input, conversation history, currently executed skill by the agent, and one or more parameters associated with the currently executed skill. The system applies the ML model to the generated input to generate an expected action for the agent. The system trains the ML model by accessing a training dataset of training examples, applying the ML model to each training example, and receiving the expected action for each respective training example, where the expected action indicates whether to interrupt the conversation based on the user utterance and contextual information. The system receives an output from the ML model and generates a response to the voice input based on the output.

### CROSS REFERENCE TO RELATED APPLICATIONS

This application claims the benefit of U.S. Provisional Application No. 63/770,897, filed Mar. 12, 2025, which is incorporated by reference.

### TECHNICAL FIELD

The disclosure generally relates to the field of artificial intelligence, and more specifically relates to a declarative agent using machine learning models.

### BACKGROUND

Agents are software that coordinate sequences of interactions with AI (artificial intelligence), such as LLMs (large language models) and external software systems. Voice-based conversational agents are increasingly utilized in various interaction scenarios. Human conversations are complex and dynamic, involving subtle cues, changes in tone, pauses, and context shifts. A conversational agent that cannot understand these nuances will often respond at inappropriate times, interrupt the user, or provide irrelevant answers, which can lead to frustration and a breakdown in communication. By understanding the context and flow of a conversation, the agent can better mimic human-like interaction, making the conversation feel more natural and fluid.

### SUMMARY

Systems and methods are disclosed herein for training a machine learning model with conversation transcripts to understand context in connection with detecting a user’s verbal and non-verbal cues. The trained machine learning model identifies the right moment to provide a response, ensuring it aligns with the flow of the conversation. Specifically, the system receives a voice input from a user during a real-time conversation between the agent and the user and applies the trained machine learning model to the voice input. The machine learning model is trained based on a training dataset including a plurality of training examples. Each training example includes at least a conversation, user utterance, contextual information and an expected response associated with the conversation. The machine learning model outputs an expected action for the agent based on the voice input from the user. The system generates a response to the voice input based on the expected action.

Training a machine learning model with conversation transcripts to understand the context of conversations enhances the capabilities of conversational agents, such as chatbots and voice assistants. This approach focuses on equipping the model with the ability to comprehend the nuances of human dialogue, thereby enabling it to make intelligent decisions about when to respond, interrupt, or stay silent. By developing an in-depth understanding of conversational dynamics, such as turn-taking, utterance boundaries, collaborative overlapping, sentiment, emotions, and context, the model may make informed decisions about when and how to respond, whether to interrupt, or stay silent. In this way, the agent of the declarative agent service may reduce misunderstandings and interruptions and communicate simultaneously in a natural and contextual way, while enhancing the overall conversational experience.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 illustrates one embodiment of a system environment for implementing a declarative agent service, in accordance with one or more embodiments.

FIG. 2 illustrates one embodiment of modules of the declarative agent service, in accordance with one or more embodiments.

FIG. 3 is a flowchart of a method 300 for generating a response to a voice input, in accordance with one or more embodiments.

FIG. 4 is a block diagram illustrating components of an example machine able to read instructions from a machine-readable medium and execute them in a processor (or controller) , in accordance with one or more embodiments.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

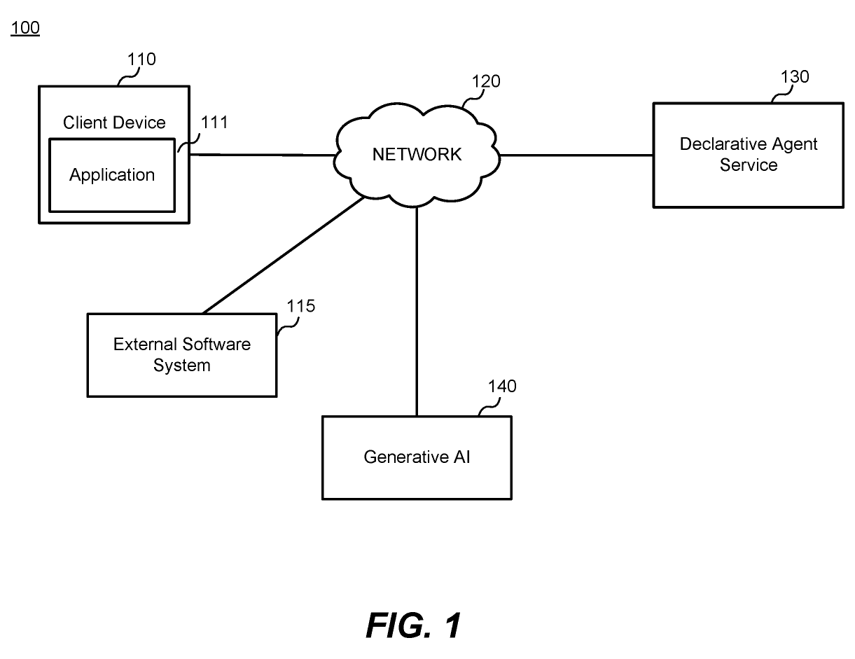

FIG. 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone or feature phone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130’s functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

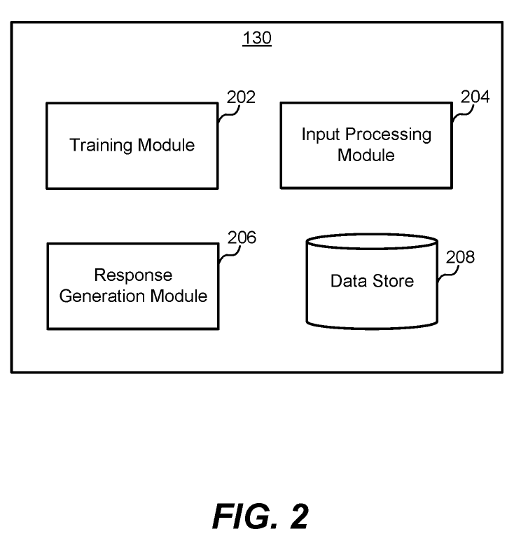

Declarative agent service 130 is used by client devices 110 and/or security device 113) and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of declarative agent service 130. As depicted in FIG. 2, the declarative agent service 130 includes a model training module 202, an input processing module 204, a response generation module 206, and a data store 208. These modules and databases are merely illustrative; fewer or more modules and/or databases may be used to achieve the functionality disclosed herein.

The model training module 202 trains a machine learned model (e.g., a large language model – LLM) that understands context, non-verbal cues (e.g., laughter, emotion cues, etc.), and verbal cues (e.g., utterance, tones, etc.) in a conversation, manages turn-taking, performs collaborative overlapping, and responds to the user’s input. Collaborative overlapping is when one speaker talks while another is still speaking, but instead of being an interruption, it serves as a way to show engagement, agreement, or enthusiasm. It often happens in lively, cooperative conversations where participants are actively involved and encouraging each other. The model processes the user’s verbal cues and non-verbal cues to extract meaning, intent, and important details such as topics, entities, or emotions. This ability allows the model to go beyond surface-level interactions and comprehend the underlying purpose of the conversation. By leveraging advanced natural language processing (NLP), the model may interpret both explicit information and subtle cues in the user’s message. In some embodiments, the model manages the flow of the conversation through turn-taking and/or collaborative overlapping. The trained model determines the right moment to respond by analyzing linguistic and conversational cues, such as pauses or phrases signaling the end of a user’s input. The timing of the responses as well as the content of the responses are managed to avoid interruptions or awkward silences, creating a smooth conversational experience.

In human conversations, turn-taking is a natural process where speakers alternate between speaking and listening. The model training module 202 may train the model to identify cues that signal when a speaker has finished their turn, such as pauses, changes in intonation, or specific phrases. The model training module 202 may also train the model to recognize utterance boundaries, e.g., when a user has completed their utterance so that the agent of the declarative agent service 130 may respond timely. For example, an utterance may end with a period, a question mark, etc. the model learns to recognize these boundaries based on the context and conversation patterns so that the agent of the declarative agent service 130 may distinguish between a complete statement and a pause that may suggest more is to come. In some embodiments, the model training module 202 may train the model to understand the context of an ongoing conversation, for example, remembering previous parts of the conversation, understanding the topic being discussed, recognizing the user’s emotional state and the like. For instance, upon receiving a 10-digit number, the agent of the declarative agent service 130 may understand a user has completed their input if the number is for a phone number; whereas the user may have not completed their input if they were asked for a tracking number. This contextual awareness helps the agent make informed decisions about when to respond or interject.

In some embodiments, the agent of the declarative agent service 130 may perform collaborative overlapping. The model training module 202 may train the model to determine a timing to overlap with the user’s input by analyzing user input, detecting emotions, understanding conversational context, and recognizing pauses in the interactions. For instance, in text-based conversations, the model may be trained to monitor keystrokes or input buffers and identify when a user hesitates or pauses mid-sentence. For example, if a user types “I was thinking about going to…” and pauses, the agent of the declarative agent service 130 may interject with a predictive response like, “Oh, are you thinking of a new place to eat?” This can be implemented using event identifiers and/or listeners that track typing patterns and detect pauses before generating an appropriate response.

In some embodiments, the model may be trained to detect sentiment and emotion to determine when overlapping would feel natural. The model training module 202 may train the model to detect verbal cues, such as, “I’m very disappointed!”, “Oh my goodness!”, etc., and/or non verbal cues, such as laughter, sigh, finger snapping, etc., to determine the user’s sentiment and emotion, e.g., assessing whether the user is expressing excitement, enthusiasm, or high emotional intensity. For instance, if a user begins with “Oh my gosh, I just got…,” the model may analyze the sentiment and generate a collaborative overlapping response, e.g., “… some great news? Tell me more!” to keep the conversation engaging. In some embodiments, the model training module 202 may be trained to detect pauses and pitch changes in a voice-based conversation. For instance, pauses (300-600 milliseconds) or rising pitch at the end of a phrase often indicate that a speaker is not finished. If a user’s voice input contains a short pause and a rising intonation, the model may inject a collaborating overlapping response, such as, “Oh, go on! What happened next?”, creating a more dynamic and interactive experience.

Once an overlapping timing is detected, the model may generate a collaborative overlapping response. A collaborative overlapping response may encourage the user to continue (e.g., “Oh really? Tell me more!”), predict the user’s next phrase (e.g., “You got a new job?”), or express engagement (e.g., “Wow, that sounds exciting!”). In some implementations, the model may include a large language model that generates natural, context-aware responses.

In some implementations, the model training module 202 generates a training dataset that includes a plurality of conversations which are used as training examples for training the machine learning mode. The conversations may be collected from historical, natural conversations, which may be sourced from human-to-human interactions like chat logs, forums, or recorded dialogues. In some embodiments, the conversations are in the form of conversational transcripts, which are derived from various sources, such as customer service interactions, chat logs, recorded phone calls, or any other context where dialogues occur. The training dataset may capture a wide range of conversational scenarios, styles, tones, etc., including both professional and casual settings so that the machine learned model is exposed to different types of conversations and communication styles. In some embodiments, the training dataset may be stored in a data store, e.g., the data store 208 of declarative agent service 130.

The model training module 202 may annotate the conversations by labeling the conversations to indicate various conversational features, and use the labeled conversations to generate training examples. For example, the model training module 202 may label a conversation when an utterance requires an immediate response, a delayed response, or no response at all. For instance, a direct question like “How do I fix this?” signals the need for an immediate reply, whereas a reflective statement like “I’m not sure about this plan...” may only require engagement if the user seeks input. In some embodiments, the model training module 202 may label the conversations with turn-taking cues, such as pauses or changes in tone, to teach the model when to wait for the user to finish and when to interject. The model training module 202 uses these labeled conversations to train the model to understand how to respond appropriately, based on both the content and the timing of each utterance.

In some embodiments, the training examples may include real-time signals, such as typing indicators, pauses, etc., which are used for training the model’s responsiveness. These signals may inform the agent of the declarative agent service 130 about when to wait before responding. For example, if a user pauses mid-sentence, the agent should recognize these signals and refrain from interrupting. The model training module 202 labels the training examples with pauses of varying lengths so that the model learns whether the user is reflecting or still formulating their thoughts. By incorporating real-time cues in the training examples, the model may be trained to dynamically adjust its responses based on the pace of the conversation.

The model training module 202 uses the training examples as input to the machine learning model. In some examples, the training examples may be converted into a format that is suitable for the model. In some embodiments, the input to the model may include a training example with the associated current user utterance, context (a series of prior conversation turns), and any additional features such as intent labels, emotional tone, or turn-taking cues. The model may be trained to output an expected action of the agent of the declarative agent service 130, such as generating a text response, predicting a turn boundary, or deciding when to stay silent. For example, in a customer service scenario, the input may include a customer query and prior conversation context, while the output may specify a relevant response generated by the agent.

In some embodiments, the machine learning model may include transformer-based models, large language models (LLMs), such as GPT, T5, or BERT. In some examples, the machine learning model may include an encoder-decoder architecture for sequence-to-sequence tasks like response generation, an encoder-only architecture for tasks like intent classification, or a decoder-only architecture for generative conversational AI.

The model training module 202 may feed batches of training examples into the machine learning model. In some implementations, the training process includes a forward pass, where the model processes inputs, encodes the utterances, emotions, and context, and predicts outputs such as the next response. In some implementations, the training process may include a backward pass, where errors between the model’s prediction and the ground truth (the expected output) are calculated using a loss function, and the model’s weights are updated through backpropagation. In some implementations, the model training module 202 may set up a loss function and/or an optimization objective. A loss function is a function that generates a score for the output of the machine-learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. During training, the model training module 202 may track metrics such as training loss, validation loss, and specific task-related scores to monitor the model’s performance. For instance, a consistently decreasing training loss indicates that the model is learning, while validation loss ensures the model generalizes well to unseen data. The model training module 202 updates the set of parameters for the machine-learning model based on the score generated by the loss function. For example, the model training module 202 may apply gradient descent to update the set of parameters.

Once the model is trained, the model is saved along with its weights, tokenizer configurations, and training parameters for deployment or further fine-tuning. The saved model may then be integrated into a conversational pipeline of the declarative agent service 130 for real-world use. When receiving a new user input, the declarative agent service 130 may apply the trained machine learning model to the user input and output the expected actions for the agent of the declarative agent service 130. In some embodiments, the trained model may be stored in a data store such as data store 208 of the declarative agent service 130.

In some implementations, feedback on response output from the machine learning model may be collected to update/retrain the model. For example, if users correct the responses or indicate that the agent misunderstood their query, this information may be used as feedback. In some implementations, humans may review the generated response to evaluate the model’s accuracy and identify any recurring issues. Based on the feedback analysis, the model training module 202 may update the training dataset to include new examples, corrections, or additional variations of existing queries that reflect the identified issues. The model training module 202 may adjust the models in its architecture, hyperparameters, or training approach based on the feedback. For instance, if the feedback indicates a frequent misunderstanding of certain phrases, updating the training dataset to include these examples and retraining the model with examples of these phrases may improve accuracy. In some cases, incremental learning techniques may be applied, allowing the model to be updated with new data without requiring a full retrain from scratch. Through this iterative process of learning from real-world feedback and regularly updating the model, the machine learning model may maintain high standards of conversational timing and responsiveness while remaining flexible and adaptive to new challenges and user expectations.

The input processing module 204 receives a user’s input and transforms it into an input to the machine learning model. In some implementations, the input processing module 204 may receive the user input via a conversational interface (e.g., a chat window, voice input, or API). The input may be a text message, voice input (transcribed to text), or another type of communication. The input processing module 204 may preprocess the user input. In one example, the input processing module 204 may tokenize the user input, where the input text is broken down into smaller units such as words or sub-words so that unstructured natural language may be converted to structured information. In one example, the machine learning model may be an LLM, and the input processing module 204 may generate a prompt to the LLM using the user input. In some embodiments, the input processing module 204 may incorporate contextual information with the user input as input to the machine learning model. The contextual information may include prior exchanges, such as a previous user query, and the input processing module 204 may combine the current user input with the conversation history. In some implementations, the input processing module 204 extracts relevant features such as sentiment, intent, and turn-taking cues. Sentiment analysis helps detect the emotional tone of the message (e.g., frustration or happiness), while intent classification identifies the purpose of the user's message (e.g., a request for refund status). The input to the machine learning model may include a current user input and the associated current user utterance, context (a series of prior conversation turns), and any additional features such as intent labels, emotional tone, or turn-taking cues.

The response generation module 206 receives the prepared input and applies the machine learning model to generate an appropriate response or action. After the model processes the input, it produces its output. In some embodiments, the machine learning model may output raw outputs, such as tokens. The response generation module 206 may post-process the output and generate a response to the user input. In some examples, the response generation module 206 may detokenize the output, by converting the model’s predicted tokens back into human-readable text. In some examples, the machine learning model may be an LLM, and the output form the machine learning model may be a generated response that the agent uses as a response to the user. The response may be adjusted to match the tone and context of the conversation. In some examples, if the output is not a direct response but an action (such as a system command or an event trigger), the response generation module 206 translates this into the necessary system action. For example, if the model detects that a user has asked a question requiring further clarification, it may trigger a follow-up question instead of a direct response.

In one example, the declarative agent service 130 deploys the trained machine learning model that detects the user’s utterances and generates the appropriate agent response. In one example, a user is interacting with a conversational agent to provide a tracking number for an item or an order verification:

User: "Hi, I still have not received the ZZZ for my recent purchase."

Agent: "Sure, I can help with that. Can you please provide your tracking number?"

User: "Alright, it's 1234..." (pauses)

Agent: (Waits, recognizing the pause as the user might be looking for the information or reading it out)

User: "...5678 9101 1121. ….."

Agent: "Thank you for providing your tracking number. Can you also provide the receiver’s name?"

User: "Oh, yes, it's AAA."

Agent: "Great, your payment is being processed now. Is there anything else I can assist you with?"

In this example, when the agent asks for the tracking number and the user begins to provide it (“Alright, it's 1234...”), the user pauses after giving the first few digits. Rather than prematurely assuming that the user has finished speaking and interrupting with a response, leading to confusion or frustration, the declarative agent service 130 deploys the trained machine learning model which recognizes that the user has likely paused to read out the next part of their tracking number. The model detects this pause as part of a natural speech pattern rather than the end of an utterance. It understands that in the context of providing tracking, a pause is expected as users often take a moment to read out the next set of numbers. By recognizing this as an incomplete utterance, the agent waits instead of interrupting, allowing the user to continue without disruption.

In some embodiments, the declarative agent service 130 deploys the trained machine learning model to a user’s input to analyze the conversation and determine whether the user’s input is complete and whether an agent of the declarative agent service 130 needs to respond, collaboratively overlap, or interrupt the conversation. In one implementation, the input processing module 204 receives a user input, e.g., a voice message, from a user during a conversation. The input processing module 204 transforms the user’s voice message into an input to the machine learning model. The input processing module 204 may transcribe the voice message to text, including transcribed user utterance. The user utterance may be associated with a set of parameters, such as silence duration, amplitude threshold, etc., which are used to describe the user utterance. The silence duration determines how long the declarative agent service 130 will wait during a pause before deciding the user has finished speaking. A short duration may interrupt users who are pausing to think, while a long duration can make the agent feel unresponsive. Similarly, the amplitude threshold is used to filter out minor sounds like breathing or ambient noise, which might otherwise be mistaken for speech.

The input to the machine learning model may include conversation history that provides the context for how the current utterance fits into the ongoing dialogue. The conversation history may include the user’s and the agent’s previous exchanges. For instance, if the agent has just asked the user for a specific piece of information, this conversation history can be used to check whether the user’s response addresses that request. The input to the machine learning model may include currently executed skills of the declarative agent service 130. The skills refer to various action modes of the agent of the declarative agent service 130, such as making an inquiry, responding to the user, providing instructions, etc. The input processing module 204 includes the currently executed skills that may be formed as part of the input to the machine learning model which may be used to determine whether the user’s input is on track. The currently executed skills may be associated with a set of parameters which may be relevant information for deploying the corresponding skills.

The input processing module 204 may generate the input to the machine learning model by tokenizing the transcribed user input, conversation history, currently executed skills, and the parameters associated with the skills into smaller units, e.g., tokens. In some implementations, the tokens are numerical representations of words, punctuation, or other elements. The input processing module 204 applies the machine learning model to the generated input to determine whether the user has completed the voice input. The machine learning model may output a decision about whether to interrupt the user or wait for them to finish their input. For instance, if the input is syntactically incomplete (e.g., trailing phrases like “on...”), semantically lacking (missing crucial details like time and date), or if the conversation context suggests the user is likely to continue, the machine learning model may decide not to interrupt and output a recommendation to let the user finish. If the input appears complete and the currently executed skill can be fulfilled, the machine learning model may interrupt and take the next action. In some embodiments, the output may include a confidence score, which indicates how certain the machine learning model is about its decision. For instance, a confidence score of 0.95 means the machine learning model is highly confident that the input is complete.

In some implementations, the machine learning model may determine the one or more silence duration thresholds. When the silence duration reaches a corresponding threshold, the machine learning model may generate a response to the user input. For example, when the declarative agent service 130 determines the user has completed the voice input, the machine learning model may use a shorter silence duration threshold (e.g., 2 seconds). Once the silence duration reaches 2 seconds, the declarative agent service 130 may provide the response to the user to mimic natural conversation flow. In another example, when the machine learning model determines the user has not completed the voice input, the machine learning model may use a longer silence duration threshold (e.g., 5 seconds) to give the user more time to complete the voice input.

The data store 208 stores data used by the declarative agent service 130. For example, the data store 208 stores user data, previous conversation, etc. for use by the declarative agent service 130. The data store 208 also stores trained machine-learning models trained by the model training module 202. For example, the data store 208 may store the set of parameters for a trained machine-learning model on one or more non-transitory, computer-readable media. The data store 208 uses computer-readable media to store data, and may use databases to organize the stored data.

### Example Method

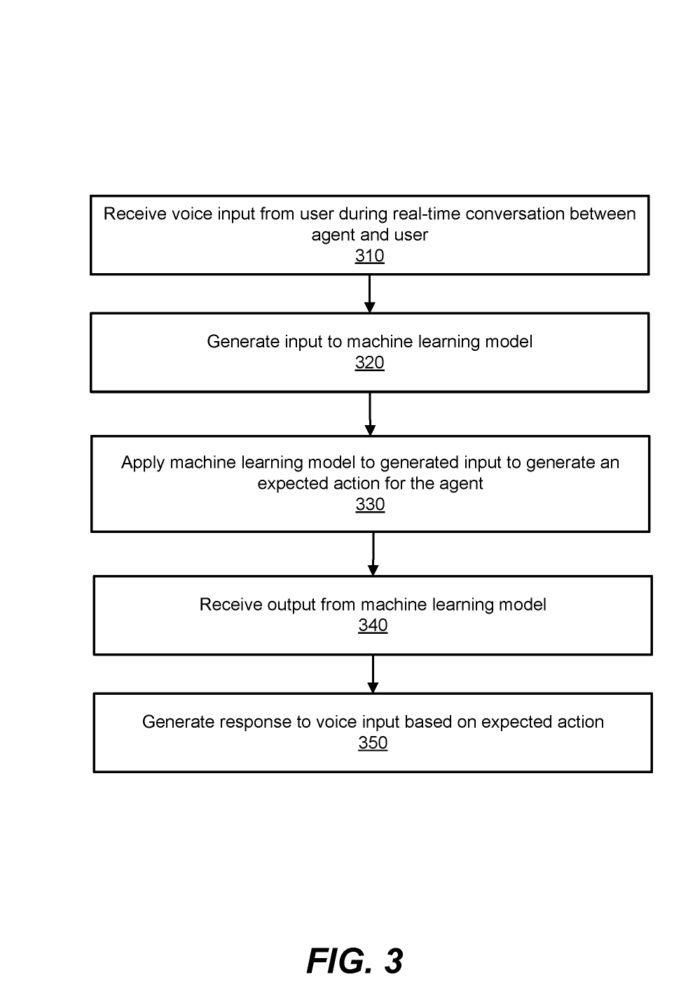

FIG. 3 is a flowchart of a method 300 for generating a response to a voice input, in accordance with one or more embodiments. In some embodiments, additional or alternative steps to those described in relation to FIG. 3 may be performed by the declarative agent service 130. Further, additional or alternative components to those described in relation to FIG. 3 may be used to perform the method.

The method 300 begins with receiving 310, by an agent, a voice input from a user during a real-time conversation between the agent and the user. The input processing module 204 generates 320 an input to a machine learning model. The input may include at least a user utterance in the voice input, conversation history, currently executed skill by the agent, and one or more parameters associated with the currently executed skill. The response generation module 206 applies 330 the machine learning model to the generated input to generate an expected action for the agent.

The training module 202 may train the machine learning model by accessing a training dataset comprising a plurality of training examples. In some embodiments, the training dataset is determined by accessing a set of historical human-to-human interactions and extracting, from each human-to-human interaction, the conversation, user utterance, contextual information and an expected response associated with the conversation. Each training example may include at least a conversation, user utterance, contextual information and an expected response associated with the conversation. In some embodiments, each expected response includes a predicted next phrase to be used by a respective user. In some embodiments, each training example further comprises a label indicating an urgency for the respective expected response. The label may indicate when an utterance requires an immediate response, a delayed response, or no response at all. In some embodiments, each training example includes one or more real-time signals associated with the respective conversation. The real-time signals may include typing indicators and pauses in the respective user utterance.

The training module 202 applies the machine learning model to each of the plurality of training examples and receives the expected action for each respective training example. The expected action may include at least whether to interrupt the conversation based on the user utterance and contextual information. In some embodiments, the expected action includes an indication of whether the agent needs to respond, collaboratively overlap, or interrupt the respective conversation. The response generation module 206 receives 340 an output from the machine learning model, the output comprising the expected action for the agent. The response generation module 206 generates 350 a response to the voice input based on the expected action.

In some embodiments, receiving the output from the machine learning model further comprises causing the agent to refrain from interrupting the conversation.

In some embodiments, receiving the output from the machine learning model comprises determining a silence duration included in the voice input, determining a threshold for the silence duration, determining whether the silence duration exceeds the threshold, and responsive to determining that the silence duration exceeds the threshold, receives the expected action comprising interjecting the conversation between the user and the agent.

In some embodiments, training the machine learning model further comprises implementing a forward pass that causes the machine learning model to process inputs, encodes user utterances, emotions, and context, and predict expected responses, implementing a backward pass by calculating errors in the machine learning model’s expected responses using a loss function, and updating the machine learning model’s weights through backpropagation.

In some embodiments, the response generation module 206 causes a client device 110 to present the response to the voice input. The response generation module 206 receives user feedback regarding the presented response from the client device 110 and generates a new training example based on the real-time conversation. The training example may include the user feedback. The training module 202 may train the machine learning model on the new training example.

In some embodiments, generating a response to the voice input based on the expected action comprises detokenizing the output into human-readable text and adjusting the human-readable text to match tone and context of the real-time conversation.

### Computing Machine Architecture

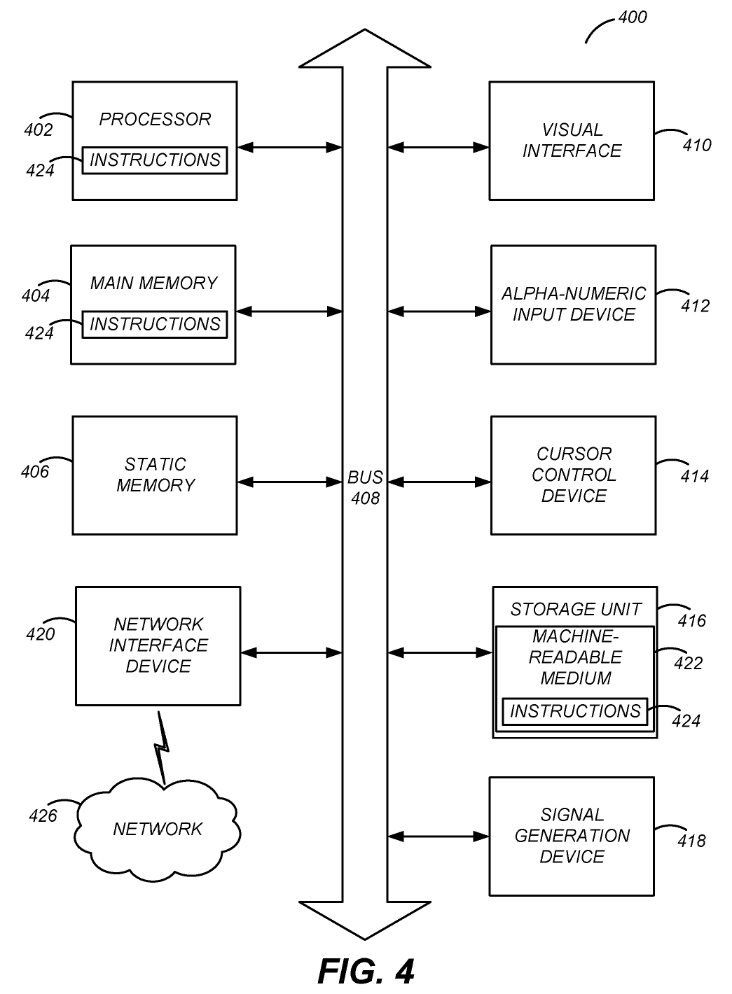

FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor’s cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by performance, cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a voice input from a user during a real-time conversation between the agent and the user;
generating an input to a machine learning model, the input comprising at least a user utterance in the voice input, conversation history, currently executed skill by the agent, and one or more parameters associated with the currently executed skill;
applying the machine learning model to the generated input to generate an expected action for the agent, wherein training the machine learning model comprises:
accessing a training dataset comprising a plurality of training examples, each training example comprising at least a conversation, user utterance, contextual information and an expected response associated with the conversation;
applying the machine learning model to each of the plurality of training examples; and
receiving the expected action for each respective training example, the expected action comprising at least whether to interrupt the conversation based on the user utterance and contextual information;
receiving an output from the machine learning model, the output comprising the expected action for the agent; and
generating a response to the voice input based on the expected action.

2. The method of claim 1, wherein receiving the output from the machine learning model comprises:
refraining from interrupting the conversation.

3. The method of claim 1, wherein receiving the output from the machine learning model comprises:
determining a silence duration included in the voice input;
determining a threshold for the silence duration;
determining whether the silence duration exceeds the threshold; and
responsive to determining that the silence duration exceeds the threshold, receiving the expected action comprising interjecting the conversation between the user and the agent.

4. The method of claim 1, wherein the response includes a predicted next phrase to be used by the user based on the voice input.

5. The method of claim 1, the training dataset determined by:
accessing a set of historical human-to-human interactions; and
extracting, from each human-to-human interaction, the conversation, user utterance, contextual information and an expected response associated with the conversation.

6. The method of claim 1, wherein each training example further comprises a label indicating an urgency for the respective expected response.

7. The method of claim 1, wherein each training example further comprises one or more real-time signals associated with the conversation, wherein real-time signals include typing indicators and pauses in the respective user utterance.

8. The method of claim 1, wherein training the machine learning model further comprises:
implementing a forward pass that causes the machine learning model to process inputs, encodes user utterances, emotions, and context, and predict expected responses;
implementing a backward pass by calculating errors in the machine learning model’s expected responses using a loss function; and
updating the machine learning model’s weights through backpropagation.

9. The method of claim 1, further comprising:
causing presentation of the response to the voice input;
receiving user feedback regarding the presented response;
generating a new training example based on the real-time conversation, wherein the training example includes the user feedback; and
training the machine learning model on the new training example.

10. The method of claim 1, wherein generating a response to the voice input based on the expected action comprises:
detokenizing the output into human-readable text; and
adjusting the human-readable text to match tone and context of the real-time conversation.

11. The method of claim 1, wherein the expected action further comprises one or more of an indication of whether the agent needs to respond, collaboratively overlap, or interrupt the respective conversation, and wherein one or more of these expected actions are performed separately or simultaneously.

12. A non-transitory computer-readable storage medium storing instructions that, when executed, cause a processor to perform steps comprising:
receiving, by an agent, a voice input from a user during a real-time conversation between the agent and the user;
generating an input to a machine learning model, the input comprising at least a user utterance in the voice input, conversation history, currently executed skill by the agent, and one or more parameters associated with the currently executed skill;
applying the machine learning model to the generated input to generate an expected action for the agent, wherein training the machine learning model comprises:
accessing a training dataset comprising a plurality of training examples, each training example comprising at least a conversation, user utterance, contextual information and an expected response associated with the conversation;
applying the machine learning model to each of the plurality of training examples; and
receiving the expected action for each respective training example, the expected action comprising at least whether to interrupt the conversation based on the user utterance and contextual information;
receiving an output from the machine learning model, the output comprising the expected action for the agent; and
generating a response to the voice input based on the expected action.

13. The non-transitory computer-readable storage medium of claim 12, wherein receiving the output from the machine learning model comprises:
refraining from interrupting the conversation.

14. The non-transitory computer-readable storage medium of claim 12, wherein receiving the output from the machine learning model comprises:
determining a silence duration included in the voice input;
determining a threshold for the silence duration;
determining whether the silence duration exceeds the threshold; and
responsive to determining that the silence duration exceeds the threshold, receiving the expected action comprising interjecting the conversation between the user and the agent.

15. The non-transitory computer-readable storage medium of claim 12, wherein the response includes a predicted next phrase to be used by the user based on the voice input.

16. The non-transitory computer-readable storage medium of claim 12, the training dataset determined by:
accessing a set of historical human-to-human interactions; and
extracting, from each human-to-human interaction, the conversation, user utterance, contextual information and an expected response associated with the conversation.

17. The non-transitory computer-readable storage medium of claim 12, wherein each training example further comprises a label indicating an urgency for the respective expected response.

18. The non-transitory computer-readable storage medium of claim 12, wherein each training example further comprises one or more real-time signals associated with the conversation, wherein real-time signals include typing indicators and pauses in the respective user utterance.

19. The non-transitory computer-readable storage medium of claim 12, wherein training the machine learning model further comprises:
implementing a forward pass that causes the machine learning model to process inputs, encodes user utterances, emotions, and context, and predict expected responses;
implementing a backward pass by calculating errors in the machine learning model’s expected responses using a loss function; and
updating the machine learning model’s weights through backpropagation.

20. A system comprising:
a processor; and
a non-transitory computer-readable storage medium storing instructions that, when executed, cause the processor to perform actions comprising:
receiving, by an agent, a voice input from a user during a real-time conversation between the agent and the user;
generating an input to a machine learning model, the input comprising at least a user utterance in the voice input, conversation history, currently executed skill by the agent, and one or more parameters associated with the currently executed skill;
applying the machine learning model to the generated input to generate an expected action for the agent, wherein training the machine learning model comprises:
accessing a training dataset comprising a plurality of training examples, each training example comprising at least a conversation, user utterance, contextual information and an expected response associated with the conversation;
applying the machine learning model to each of the plurality of training examples; and
receiving the expected action for each respective training example, the expected action comprising at least whether to interrupt the conversation based on the user utterance and contextual information;
receiving an output from the machine learning model, the output comprising the expected action for the agent; and
generating a response to the voice input based on the expected action.
